(19) United States
(12) Patent Application Publication
(10) Pub. No.: US 2009/0142466 A1
(43) Pub. Date: Jun. 4, 2009

(54) PROCESSING DEVICE AND METHODS OF USE

(76) Inventors: Anne Christine Robinson, Golden Bay (NZ); Lance William Robinson, Golden Bay (NZ)

Correspondence Address: GREER, BURNS & CRAIN, 300 S WACKER DR, 25TH FLOOR, CHICAGO, IL, 60606, US

(21) Appl. No.: 11/995,664

(22) PCT Filed: Jul. 14, 2006
(86) PCT No.: PCT/NZ2006/000176

§ 371 Date: Jul. 11, 2008

(30) Foreign Application Priority Data
Jul. 14, 2005 (NZ) 537989

(51) Int. Cl. A23G 9/20; A47J 43/00

(52) U.S. Cl. 426/565; 99/485; 426/519; 366/318

(57) ABSTRACT

A device is described for the production of an aerated and mixed product such as a frozen fruit treat. The device includes an auger that has two threaded sections and two separate shaped sections. In addition, the frozen material is fed to the auger in a right angle direction to the axis of the auger. The device results in a product with improved aeration properties and is fully mixed.

### TECHNICAL FIELD

The invention relates to a processing device and methods of use. More specifically, the invention relates to a device that is capable of taking frozen blocks of material such as a fruit only mixture, fruit and cream, or fruit and yoghurt, mixtures and shearing the material in a way that maximises the shear force and material aeration to form a well aerated and mixed ice-cream like product.

### BACKGROUND ART

Processing devices that shear products are known in the prior art to form a variety of products in the food and other industries.

A popular treat is a cream freeze or fruit sorbet. A variety of prior art devices exist relating to producing such cream freeze, fruit sorbet or ice-cream like products that rely on shear forces to mix and aerate the material used.

U.S. Pat. No. 5,208,050 describes a dispensing system for frozen yogurt or ice cream. The system uses a device that includes a cylindrical cup inside which the frozen mix is squeezed out of an orifice on the underside of the cup via a vertically mounted piston.

U.S. Pat. No. 4,708,489 describes a blending apparatus that has a conical shaped container with a corresponding conical shaped screw auger. Product is placed into the container and the auger is then forced vertically into the blending container which forces the product out of a nozzle at the pointed end of the conical shaped container.

U.S. Pat. No. 5,208,050 describes a dispensing system for frozen yoghurt or ice cream. The system has a cup where the serving of confectionary is placed. A cutter is then lowered vertically into the cup to mix the confectionary. Once mixed, the cutter is removed vertically from the cup and the mixture is extruded out the bottom of the cup via a set of groves into a storage cup. The mixer is described as having a series of spokes that aerate the mixture.

U.S. Pat. No. 7,017,783 relates to a dispensing pack and machine for products including ice cream. In use, the machine holds a pack containing the base ice cream within a frame. Above the frame is a ram that when pushed down on the pack vertically, forces the pack contents to be expelled though a nozzle of the pack and into a collection container.

U.S. Patent Application No. 2005/0183426 describes a dessert machine that can mix frozen yoghurt or ice cream. The machine has a tapered auger with a fine bladed thread that rotates around the cone shaped auger. The machine also has a corresponding conical shaped mixing chamber. The product is mixed in the conical shaped mixing chamber and then dispensed though an aperture at the tapered end of the mixing chamber by vertically pushing the auger into the chamber.

The above devices all work on the principle of adding a raw material to a container and then vertically plunging the mixture via an orifice. Little consideration is given to entraining air into the mixture which the inventor has found is beneficial to give the product more texture. Further, little consideration is given to using hard frozen material in a frozen form. It is envisaged by the inventor that many of the prior art devices would simply not operate (not plunge) if the raw material is in a frozen state as it would be too hard to break down and pass through the orifice. Thus, in order to operate properly, the raw material must ordinarily be in a semi frozen state in order to be able to be plunged via the orifice. It should be appreciated that ideally being able to process a frozen material is preferable to prevent food deterioration and to make it easier to handle the raw material. Further, having a device that can produce a treat without the need for further additives or emulsifying agents would be an advantage.

It is an object of the present invention to address the foregoing problems or at least to provide the public with a useful choice.

All references, including any patents or patent applications, cited in this specification are hereby incorporated by reference. No admission is made that any reference constitutes prior art. The discussion of the reference states what their authors assert, and the applicants reserve the right to challenge the accuracy and pertinency of the cited documents. It will be clearly understood that, although a number of prior art publications are referred to herein, this reference does not constitute an admission that any of these documents forms parts of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

For the purposes of this specification, the term ‘auger’ refers to a device shaped for producing, when revolved, motion or pressure in the direction of its axis.

According to one aspect of the present invention there is provided a device to produce a product from frozen material including
an auger and surrounding mixing tube;
and wherein frozen material enters the mixing tube at a right angle to the axis of the auger and mixing tube; and,
characterised in that the auger includes at least one threaded section that cuts and shears the frozen material whilst also forcing the resulting product out of at least one orifice.

According to a further aspect of the present invention there is provided a method of producing an aerated and mixed product from a frozen block of material including the steps of:
(a) forcing the frozen material against an auger located within a surrounding mixing tube at a right angle to the axis of the auger and mixing tube;
(b) collecting the resultant product once it has passed through the auger; and
characterised in that the auger includes at least one threaded section that cuts and shears the frozen material whilst also forcing the resulting product out of at least one orifice.

Preferably, in the above device configuration and method the device auger and surrounding mixing tube includes two distinct sections being a first cylindrical section and a second conical section.

According to a further aspect of the present invention there is provided a device to produce a product from frozen material including
an auger and surrounding mixing tube;
and wherein frozen material enters the mixing tube;
characterised in that the auger and surrounding mixing tube includes two distinct sections being a first cylindrical section and a second conical section and wherein both sections act to cut and shear the frozen material whilst also moving the resulting product out of at least one orifice.

According to a further aspect of the present invention there is provided a method of producing an aerated and mixed product from a frozen block of material including the steps of:
(a) forcing the frozen material against an auger located within a surrounding mixing tube;
(b) collecting the resultant product once it has passed through the auger; and
characterised in that the auger and surrounding mixing tube includes two distinct sections being a first cylindrical section and a second conical section and wherein both sections act to cut and shear the frozen material whilst also forcing the resulting product out of at least one orifice.

Preferably, in the above device configuration and method, the frozen material enters the mixing tube at a right angle to the axis of the auger and mixing tube.

In preferred embodiments that the frozen material is made from a fruit mixture which has no additional additives, stabilisers or emulsifiers added to the mixture. In other embodiments, the block may also contain an ice cream or a yoghurt mixture or other products such as chocolate, alcohol or health products such as ginseng or vitamin boosters. It should be appreciated by those skilled in the art that, whilst the above materials and products are well suited to the device, other frozen materials requiring mixing and aeration may also be used in the device of the present invention. For example, manufacture of mousse desserts or meringue mixtures. Other non-food applications are also envisaged such as processes to create certain chemical properties such as polysaccharide chain linking. Whilst examples and discussion is now made with respect to fruit freeze or ice-cream like product manufacture, this should not be seen as limiting.

The inventor has found that by adjusting two key parameters, production of well aerated and mixed fruit freeze treat or ice-cream like product can be produced. Key parameters that the inventor has further developed are how the frozen material enters the auger and the auger shape and thread characteristics.

Preferably, the frozen material on entry to the mixing tube, is forced against the cylindrical section of the auger.

Preferably, the frozen material is in the shape of a pre-formed solid bar. In one preferred embodiment, the bar is formed in a shape that corresponds to a feed or processing chamber.

Preferably, the auger shape corresponds approximately in shape to the mixing tube sections such that the auger fits within and smoothly rotates within the mixing tube sections.

Preferably, the auger includes a fine pitch thread on the cylindrical section of the auger. In preferred embodiments the pitch is a constant width of approximately 0.25 to 3 mm wide.

Preferably, the auger also includes a helical thread that starts on the cylindrical section of the auger and rotates down the conical section of the auger. In one preferred embodiment, the helical thread pitch narrows as it progresses to the tapered end of the conical section of the auger. Preferably, the initial pitch is approximately 1.5 to 3 times wider than the pitch at the tapered end of the auger.

In one preferred embodiment, the mixing tube includes obstructions to cause rifling of material within the mixing tube. Obstructions to disrupt the flow of frozen material down the mixing tube have been found advantageous by the inventor to produce a rifling effect, in effect causing further aeration and shear forces on the frozen material as it is extruded. In one embodiment, the obstructions are protrusions extending from the interior of the mixing tube wall. More preferably, the protrusions are rectangular shaped and extend along the length of the conical section of the mixing tube wall.

Preferably, the device further includes a processing chamber which feeds frozen material to the auger and surrounding mixing tube. Preferably, the processing chamber includes a plunger and cavity. The frozen material is placed in the cavity and forced out of the chamber by the plunger.

It should be appreciated that one advantage of the processing chamber is that the chamber size may be varied and/or standardised in order to produce a desired serving of product. Larger servings would be achieved by adding multiple frozen bars. Mixed flavours could be produced by adding bars with different flavours and the auger device would then mix the flavourings to form the final product.

Preferably, the processing chamber is mounted at an approximate right angle to the axis of the auger and surrounding mixing tube.

Preferably, the process chamber and surrounding mixing tube are one integral unit which may be releasably attached to the auger. It should be appreciated that, as the process chamber and surrounding mixing tube are one unit, it is relatively simple to remove these units and clean down the device. This is of particular importance in food handling in order to prevent contamination.

In one preferred embodiment, the processing chamber includes a hinged door through which the user inserts a block of frozen material into a cavity within the processing chamber. In one method of operation envisaged by the inventor, opening and closing the door stops and starts the auger operation and the feed mechanism

Preferably, the device includes one orifice being a nozzle attachment located at the tapered end of the mixing tube conical section. In preferred embodiments, this nozzle is able to be removed and replaced with other nozzles. This is useful in cleaning as well as to alter the pattern of fruit freeze produced e.g. from a star shape to a square shape.

In preferred embodiments, the device includes a control system that runs the device simplifying the operation for the user. Cleaning systems are also envisaged as being integrated into the control system.

Preferably, the control system maintains a relative speed of the feed mechanism in correlation to the rotation speed of the auger. The inventor considers this to be important in the device operation and consistency of the end product.

Preferably, the control system is a specially programmed logic controller.

In the inventor's experience, air entrained between the auger and mixing tube is sufficient to create the desired degree of aeration. This should not be seen as limiting though as it should be appreciated that additional gas such as air may be added to the device for specific applications or to create extra aerated product.

Preferably, the device is made from stainless steel. Stainless steel is a preferred material due to its strength and other food industry accepted characteristics. This should not be seen as limiting as other materials may be used such as plastics to manufacture the device or portions of the device. It should be clear to a person skilled in the art that material choice is largely dependent on end application and may be varied without departing form the scope of the invention.

It should be appreciated by the above description that the present invention provides a number of benefits over prior art devices including:
The combination of cylindrical and conical sections creating a superior product in terms of aeration and mixing;
Locating the processing chamber and plunger in a right angle entry direction to the auger therefore improving the aeration, mixing and general ease of use;
Use and positioning of different threads on the auger to improve the aeration and mixing;
Use of obstructions in the cone section creating a rifling effect further improving the aeration and mixing;
As the device is a simple design, it is easy to manufacture and simple to use.

Another advantage includes the fact that there is minimal frozen material left in the processing chamber and/or the cone sections or nozzle after use reducing waste.

Further, as the device consists of only two key sections, (the processing chamber and mixing tube sections being one piece and the other the base), clean down is completed very easily by detaching the processing chamber and mixing tube sections.

Further, having a device that can produce a treat without the need for further additives or emulsifying agents would be an advantage.

Finally, the amount of frozen material added to the processing chamber may be easily varied and/or standardised so to the amount of final product produced can also easily be varied or standardised as required.

### BRIEF DESCRIPTION OF DRAWINGS

FIG. 1 Shows a picture of one embodiment of the processing device of the present invention in an assembled form ready for use;

FIG. 2 Shows a picture of the machine with the process chamber door in an open position;

FIG. 3 Shows a detail picture of the process chamber with frozen product being loaded into the chamber;

FIG. 4 Shows a detail picture of product being produced from the machine nozzle;

FIG. 5 Shows a plan elevation detail picture of the auger;

FIG. 6 Shows a detail picture of the interior of the mixing tube cone section; and,

FIG. 7 Shows a picture of the process chamber partially removed from the base.

### BEST MODES FOR CARRYING OUT THE INVENTION

The present invention is now described with reference to one preferred embodiment of the present invention.

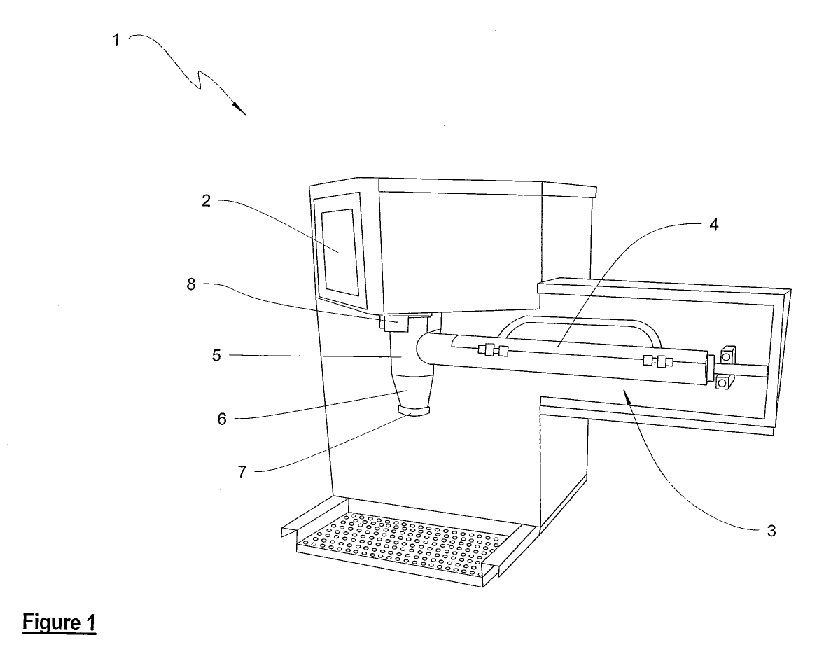

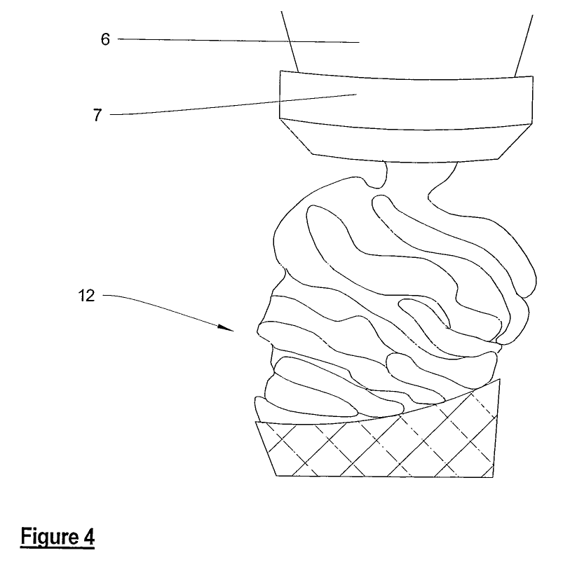

As shown in FIGS. 1 to 7, the preferred device 1 includes:
A control system and interface 2
A processing chamber 3
A base portion 8
A mixing tube cylindrical section 5 and
A mixing tube conical section 6.

The processing chamber 3 includes a door 4 which may be opened to insert frozen material 11 into the cavity 10 within the processing chamber 3. The processing chamber 3 includes a plunger 9. The processing chamber 3 including the plunger 9 is mounted at an approximate right angle to the axis of the mixing tube sections 5, 6. The processing chamber 3 is located such that frozen material 11 is forced by the plunger 9 into the mixing tube cylindrical section 5.

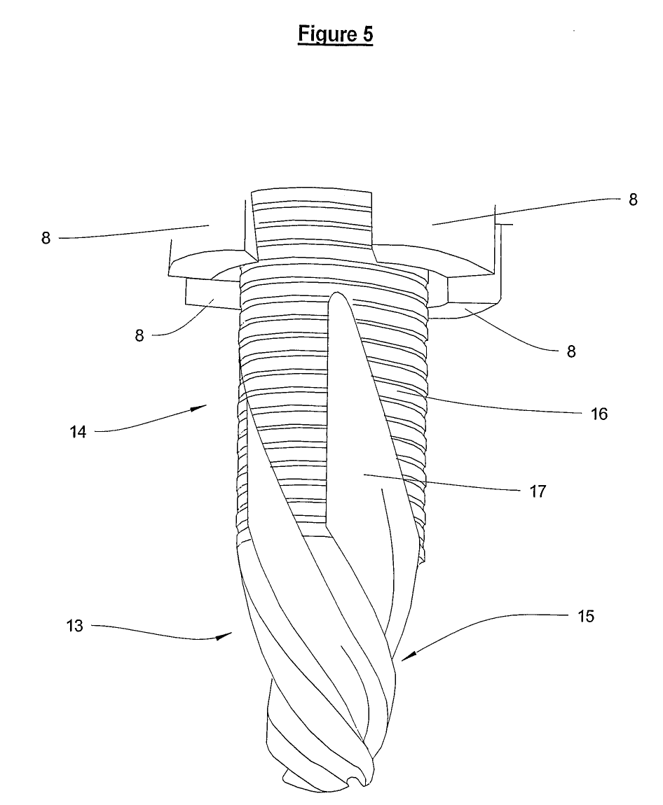

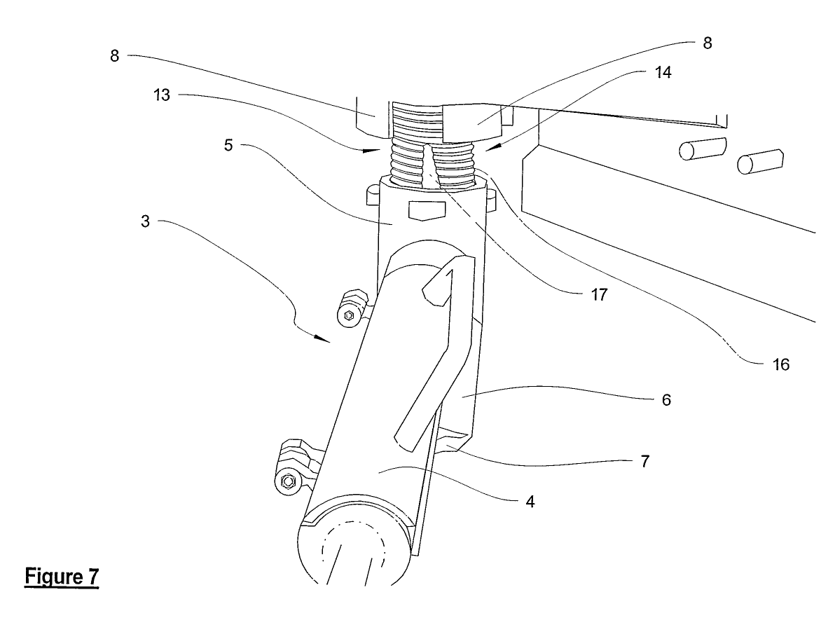

The mixing tube sections 5, 6 and the processing chamber 3 are releasably attached to the base 8. The base 8 includes an auger 13 shown in detail in FIGS. 5 and 7. The auger 13 is shaped to include an auger cylindrical section 14 and an auger conical section 15. These sections 14, 15 on the auger 13 correspond approximately in shape to the mixing tube cylindrical section 5 and mixing tube conical section 6 such that the auger 13 fits within the mixing tube sections 5, 6. The auger 13 includes a fine pitch thread 16 running down the mixing tube cylindrical section 5. A helical thread 17 is also included on the auger 13. The helical thread 17 starts on the auger cylindrical section 14 and continues down the auger conical section 15. The helical thread 17 pitch narrows as it progresses to the point of the auger conical section 15.

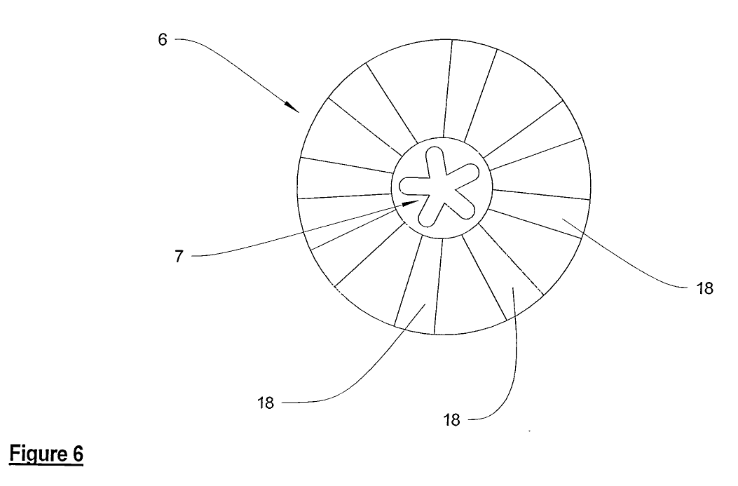

The mixing tube conical section 6 includes obstructions 18 in the form of rectangular plates of steel welded to the interior of the mixing tube conical section 6. These obstructions 18 extend along the vertical length of the mixing tube conical section 6 as shown in FIG. 6.

At the pointed end of the mixing tube conical section 6, a nozzle 7 is attached. This nozzle 7 is ideally able to be removed and re-attached. This is advantageous for cleaning as well as to vary the nozzle 7 outlet shapes. In the example shown in FIG. 6 it can be seen that the nozzle 7 has a star shape. It should be appreciated that other shapes could be used to produce varying shapes with different aesthetic appeal.

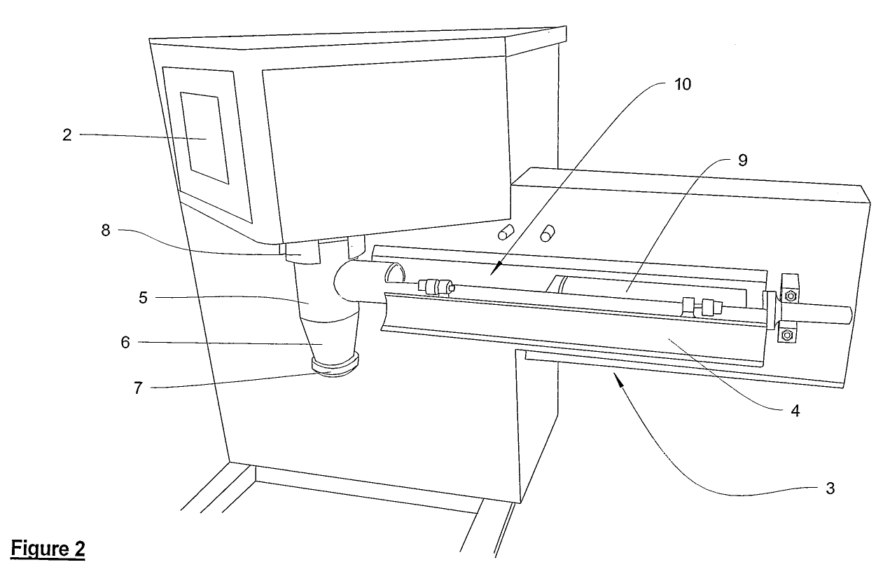

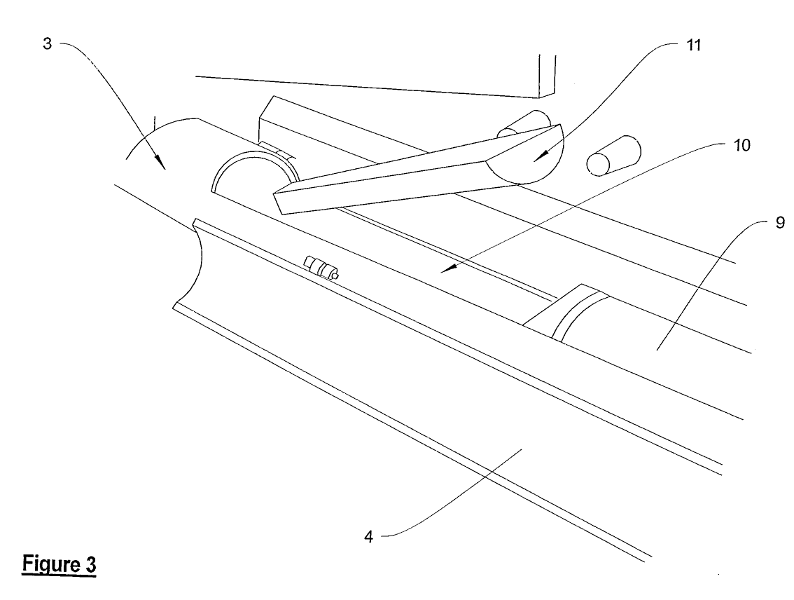

In use, the device is initially clean and ready for use as shown in FIG. 1. As shown in FIG. 2, the processing chamber 3 door 4 is opened to expose the cavity 10 for the frozen material 11. As shown in FIG. 3, a block of frozen material 11 is added to the cavity 10 in the processing chamber 3 in a position forward of the plunger 9. FIG. 3 shows one block of frozen material 11 being added. It should be appreciated that additional material 11 may be added or less used depending on the amount of final product 12 required to be produced.

The processing chamber 3 door 4 is then closed and by use of the control panel 2, the operator starts the device 1 operating. It should be appreciated that operation may also occur manually or by semi-automatic operation by rotating the auger 13 and forcing the plunger 9 forwards against the frozen material 11. Aerated and mixed final product 12 is extruded from the nozzle 7. In one embodiment, processing starts as soon as the processing chamber 3 door 4 is closed and once all frozen material 11 has been discharged, the plunger 9 returns to start position as shown in FIGS. 2 and 3.

Device 1 operation involves rotation of the auger 13 within the mixing tube sections 5, 6. Frozen material 11 is forced by the plunger 9 out of the processing chamber 3 and into the mixing tube cylindrical section 5 and against the auger 13 cylindrical section 14. The fine pitch thread 16 running down the auger cylindrical section 14 and the auger helical thread 17 act to chop, aerate and mix the frozen material 11. Mixed material is forced through the rotating action down the auger threads, and into the conical portion 15 of the auger 13. The frozen material 11 is further aerated and mixed by the rubbing action of the obstructions 18 located on the interior wall of the mixing tube conical section 6. Via the helical thread 17, product 12 is forced out of the nozzle 7.

It is the inventor's experience that the combination of cylindrical and conical sections 5, 6 and 14, 15 creates a superior product in terms of aeration and mixing. Another key improvement for aeration, mixing and general ease of use included locating the processing chamber 3 including the plunger 9 in a right angle entry direction to the auger 13. Other critical aspects include the use and positioning of the fine pitch thread 16 and helical thread 17 on the auger 13. A yet further enhancement is the use of obstructions 18 in the cone section 6 creating a rifling effect. The above combination of features produces a superior product 12 from a device 1. Further, the device 1 is simple to use and has minimal parts. A yet further advantage is that there is minimal frozen material 11 left in the processing chamber 3 and/or the cone sections 5, 6 or nozzle 7. In other methods, waste can occur due to use of containers and vertically orientated plungers.

Other advantages should also be apparent to those skilled in the art such as simple clean down. As the device consists of only two key sections, (the processing chamber 3 and mixing tube sections 5, 6 being one piece and the other the base 8), clean down is completed very easily by detaching the processing chamber 13 and mixing tube sections 5, 6. It should be appreciated that an automated clean down process may also be achieved by use of water injection to the processing chamber 3 and/or mixing tube sections 5, 6.

Further, as the amount of frozen material 11 added to the processing chamber 3 may be easily varied, the amount of final product 12 produced can also easily be varied or standardised as required. In one preferred embodiment, the frozen material 11 is a standardised shape and size bar corresponding to a single serving that is cast and frozen in a shape complementary to the processing chamber 3 cavity 10. Larger servings would be achieved by adding more than one bar. Mixed flavourings could also be achieved by adding two different flavoured bars together into the processing chamber 3 cavity 10.

Aspects of the present invention have been described by way of example only and it should be appreciated that modifications and additions may be made thereto without departing from the scope thereof as defined in the appended claims.

1. A device to produce a product from frozen material comprising:
an auger and surrounding mixing tube;
and wherein frozen material enters the mixing tube at a right angle to the axis of the auger and mixing tube; and
the auger includes at least one threaded section that cuts and shears the frozen material while also forcing the resulting product out of at least one orifice.

2. The device as claimed in claim 1 wherein the auger and surrounding mixing tube includes two distinct sections being a first cylindrical section and a second conical section.

3. A device to produce a product from frozen material comprising:
an auger and surrounding mixing tube;
and wherein frozen material enters the mixing tube;
the auger and surrounding mixing tube includes two distinct sections being a first cylindrical section and a second conical section and wherein both sections act to cut and shear the frozen material while also moving the resulting product out of at least one orifice.

4. The device as claimed in claim 3 wherein the frozen material enters the mixing tube at a right angle to the axis of the auger and mixing tube.

5. The device as claimed in claim 1 wherein the frozen material is a fruit mixture.

6. The device as claimed in claim 1 wherein the frozen material is a combination of fruit and ice cream or fruit and yoghurt mixture or includes other products such as chocolate, alcohol or health products such as ginseng or vitamin boosters.

7. The device as claimed in claim 1 wherein the product is a fruit freeze treat.

8. The device as claimed in claim 1 wherein the frozen material on entry to the mixing tube, is forced against the cylindrical section of the auger.

9. The device as claimed in claim 1 wherein the frozen material is in the shape of a pre-formed solid bar.

10. The device as claimed in claim 1 wherein the auger shape corresponds approximately in shape to the mixing tube sections such that the auger fits within the mixing tube sections.

11. The device as claimed in claim 1 wherein the auger includes a fine pitch thread on the cylindrical section of the auger.

12. The device as claimed in claim 1 wherein the auger includes a helical thread that starts on the cylindrical section of the auger and rotates down the conical section of the auger.

13. The device as claimed in claim 12 wherein the helical thread pitch narrows as it progresses to the tapered end of the conical section of the auger.

14. The device as claimed in claim 1 wherein the mixing tube includes obstructions to cause rifling of material within the mixing tube.

15. The device as claimed in claim 14 wherein the obstructions are protrusions extending from the interior of the mixing tube wall.

16. The device as claimed in claim 15 wherein the protrusions are rectangular shaped and extend along the length of the conical section of the mixing tube wall.

17. The device as claimed in claim 1 wherein the device further includes a processing chamber which feeds frozen material to the auger and surrounding mixing tube.

18. The device as claimed in claim 17 wherein the processing chamber includes a plunger and cavity and wherein the frozen material is placed in the cavity and forced out of the chamber by the plunger.

19. The device as claimed in claim 17 wherein the processing chamber mounted at an approximate right angle to the axis of the auger and surrounding mixing tube.

20. The device as claimed in claim 17 wherein the process chamber and surrounding mixing tube are one integral unit which may be releasably attached to the auger.

21. The device as claimed in claim 1 wherein a nozzle is located at the tapered end of the mixing tube conical section.

22. The device as claimed in claim 1 wherein a control system maintains a relative speed of the plunger in correlation to the rotation speed of the auger.

23. A method of producing an aerated and mixed product from a frozen block of material comprising the steps of:
(a) forcing the frozen material against an auger located within a surrounding mixing tube at a right angle to the axis of the auger and mixing tube;
(b) collecting the resultant product once it has passed through the auger; and
the auger includes at least one threaded section that cuts and shears the frozen material while also forcing the resulting product out of at least one orifice.

24. The method as claimed in claim 23 wherein the auger and surrounding mixing tube includes two distinct sections being a first cylindrical section and a second conical section.

25. A method of producing an aerated and mixed product from a frozen block of material comprising the steps of:
(a) forcing the frozen material against an auger located within a surrounding mixing tube;
(b) collecting the resultant product once it has passed through the auger; and
the auger and surrounding mixing tube includes two distinct sections being a first cylindrical section and a second conical section and wherein both sections act to cut and shear the frozen material while also forcing the resulting product out of at least one orifice.

26. The method as claimed in claim 25 wherein the frozen material enters the mixing tube at a right angle to the axis of the auger and mixing tube.

27. The method as claimed in claim 23 wherein the frozen material is a fruit mixture.

28. The method as claimed in claim 23 wherein the frozen material is a combination of fruit and ice cream or fruit and yoghurt mixture or includes other products such as chocolate, alcohol or health products such as ginseng or vitamin boosters.

29. The method as claimed in claim 23 wherein the product is a cream freeze ice cream or yoghurt.

30. The method as claimed in claim 23 wherein the frozen material on entry to the mixing tube, is forced against the cylindrical section of the auger.

31. The method as claimed in claim 23 wherein the frozen material is in the shape of a pre-formed solid bar.

32. The method as claimed in claim 23 wherein the auger shape corresponds approximately in shape to the mixing tube sections such that the auger fits within the mixing tube sections.

33. The method as claimed in claim 23 wherein the auger includes a fine pitch thread on the cylindrical section of the auger.

34. The method as claimed in claim 23 wherein the auger includes a helical thread that starts on the cylindrical section of the auger and rotates down the conical section of the auger.

35. The method as claimed in claim 34 wherein the helical thread pitch narrows as it progresses to the tapered end of the conical section of the auger.

36. The method as claimed in claim 23 wherein the mixing tube includes obstructions to cause rifling of material within the mixing tube.

37. The method as claimed in claim 36 wherein the obstructions are protrusions extending from the interior of the mixing tube wall.

38. The method as claimed in claim 37 wherein the protrusions are rectangular shaped and extend along the length of the conical section of the mixing tube wall.

39. The method as claimed in claim 23 wherein the device further includes a processing chamber which feeds frozen material to the auger and surrounding mixing tube.

40. The method as claimed in claim 39 wherein the processing chamber includes a plunger and cavity and wherein the frozen material is placed in the cavity and forced out of the chamber by the plunger.

41. The method as claimed in claim 39 wherein the processing chamber mounted at an approximate right angle to the axis of the auger and surrounding mixing tube.

42. The method as claimed in claim 39 wherein the process chamber and surrounding mixing tube are one integral unit which may be releasably attached to the auger.

43. The method as claimed in claim 23 wherein a nozzle is located at the tapered end of the mixing tube conical section.
